(19) United States
(12) Patent Application Publication
(10) Pub. No.: US 2019/0025538 A1
(43) Pub. Date: Jan. 24, 2019

(54) LENS FIXATION METHOD, HEAT CAULKING TOOL, AND LENS FIXATION DEVICE

(71) Applicant: OLYMPUS CORPORATION, Tokyo (JP)

(72) Inventor: Kazuo KOTANI, Tokyo (JP)

(73) Assignee: OLYMPUS CORPORATION, Tokyo (JP)

(21) Appl. No.: 16/142,234

(22) Filed: Sep. 26, 2018

Related U.S. Application Data
(63) Continuation of application No. PCT/JP2017/012019, filed on Mar. 24, 2017.

(30) Foreign Application Priority Data
Mar. 30, 2016 (JP) 2016-067913

(51) Int. Cl. G02B 7/02

(52) U.S. Cl. CPC G02B 7/02

(57) ABSTRACT

A lens fixation method includes: allowing a first pressing portion to come into contact with a proximal end portion of a heat caulking piece-like portion before a heat caulking tool comes into contact with a distal end portion of the heat caulking piece-like portion; pressing an outer peripheral portion of the heat caulking piece-like portion; and pressing the distal end portion of the heat caulking piece-like portion toward a caulking region, which is provided on a lens, in an axial direction of a lens frame by a second pressing portion.

This application is a continuation application based on PCT/JP2017/012019, filed on Mar. 24, 2017 and claiming priority based on Japanese Patent Application No. 2016-067913, filed in Japan on Mar. 30, 2016. The contents of both the Japanese Patent Application and the PCT Application are incorporated herein by reference.

### BACKGROUND OF THE INVENTION

### Field of the Invention

The present invention relates to a lens fixation method, a heat caulking tool, and a lens fixation device.

### Description of Related Art

Heat caulking is known as one method of fixing a lens to a lens frame (see Japanese Unexamined Patent Application, First Publication No. 2007-223121).

In a lens fixation method using heat caulking, a caulking protrusion provided at a part of a lens frame is softened by heat and is pressed inward, such that a caulked portion pressing a lens is formed. In this case, the caulking protrusion is pressed by a tool that is called a horn.

A pressing member (horn) disclosed in Japanese Unexamined Patent Application, First Publication No. 2007-223121 includes a conical pressing surface that presses a caulking protrusion and a regulating portion that protrudes downward from the outer peripheral portion of the pressing surface. The regulating portion is moved down along the outer peripheral surface of the lens frame with a predetermined gap between the outer peripheral surface of the lens frame and itself.

Japanese Unexamined Patent Application, First Publication No. 2007-223121 discloses that the generation of a burr, which is formed of a large amount of the thermally deformed caulked portion protruding outward from the outer peripheral surface, can be prevented since the regulating portion is provided in the pressing member.

### SUMMARY OF THE INVENTION

A lens fixation method of a first aspect of the invention is a lens fixation method of fixing a lens to a lens frame by putting the lens in the lens frame on which a heat caulking piece-like portion made of a thermoplastic synthetic resin is formed, and pressing a heat caulking tool against the heat caulking piece-like portion to perform heat caulking for allowing the heat caulking piece-like portion to be in close contact with the lens. When the heat caulking tool is to be pressed against the heat caulking piece-like portion, the lens fixation method includes: allowing a first pressing portion of a distal end of the heat caulking tool, to come into contact with a proximal end portion of the heat caulking piece-like portion before the heat caulking tool comes into contact with a distal end portion of the heat caulking piece-like portion; pressing an outer peripheral portion of the heat caulking piece-like portion by the first pressing portion such that the heat caulking piece-like portion is inclined toward an inner peripheral side after the first pressing portion comes into contact with the heat caulking piece-like portion; and pressing the distal end portion of the heat caulking piece-like portion toward a caulking region, which is provided on the lens, in an axial direction of the lens frame by a second pressing portion of the heat caulking tool in a state in which the first pressing portion is in contact with the heat caulking piece-like portion. The second pressing portion is closer to a proximal end of the heat caulking tool than the first pressing portion.

A heat caulking tool of a second aspect of the invention is a heat caulking tool that is held to be movable along a reference axis and presses a heat caulking piece-like portion, which is formed on a lens frame and made of a thermoplastic synthetic resin, against a lens put in the lens frame to allow the heat caulking piece-like portion to be in close contact with the lens and to fix the heat caulking piece-like portion to the lens. The heat caulking tool includes: a first pressing portion that includes a first tapered surface inclined toward the reference axis so as to form a first angle with respect to the reference axis and that is capable of pressing an outer peripheral surface of the heat caulking piece-like portion; and a second pressing portion that includes a second tapered surface adjacent to an inside from an inner edge of the first tapered surface and inclined toward the reference axis so as to form a second angle, which is larger than the first angle with respect to the reference axis, the second pressing portion being capable of pressing a distal end portion of the heat caulking piece-like portion.

According to a heat caulking tool of a third aspect of the invention, in the second aspect, an outer edge of the first pressing portion may be formed in a range equal to smaller than an outer radius of a proximal end portion of the heat caulking piece-like portion from the reference axis, and the outer edge of the first pressing portion may be provided with a distal end surface that is adjacent to an outside from an outer edge of the first pressing portion and forms a third angle, which is larger than the first angle with respect to the reference axis.

According to a heat caulking tool of a fourth aspect of the invention, in the second or third aspect, the first angle may be larger than 0° and smaller than 45°.

According to a heat caulking tool of a fifth aspect of the invention, in any one of the second to fourth aspects, an inner edge portion of the second pressing portion may be provided with a third tapered surface that protrudes from the second tapered surface and regulates a position of an inner peripheral side of the heat caulking piece-like portion to be deformed along the second tapered surface.

A lens fixation device of a sixth aspect of the invention includes: a lens frame holder that holds a lens frame on which a heat caulking piece-like portion made of a thermoplastic synthetic resin is formed such that a central axis of the lens frame is coaxial with a reference axis; the above-mentioned heat caulking tool; and a pressing unit that is configured to move the heat caulking tool along the reference axis, press the heat caulking tool against the heat caulking piece-like portion, and allow the heat caulking piece-like portion to be in close contact with a lens.

According to a lens fixation device of a seventh aspect of the invention, in the sixth aspect, the first pressing portion may be configured to come into contact with a proximal end portion of the heat caulking piece-like portion before the heat caulking tool comes into contact with a distal end portion of the heat caulking piece-like portion, and then to press an outer peripheral portion of the heat caulking piece-like portion such that the heat caulking piece-like portion is inclined toward an inner peripheral side, in a case in which the heat caulking tool is to be pressed against the heat caulking piece-like portion; and the second pressing portion may be adapted to press a distal end of the heat caulking piece-like portion toward a caulking region, which is provided on the lens, in an axial direction of the lens frame in a state in which the first pressing portion is in contact with the heat caulking piece-like portion.

### BRIEF DESCRIPTION OF THE DRAWINGS

FIG. 1 is a schematic longitudinal sectional view showing an example of a heat caulking device that is used in a lens fixation method of an embodiment of the invention.

FIG. 2 is a view seen in the direction of an arrow A of FIG. 1.

FIG. 3 is an enlarged view of a portion B of FIG. 1.

FIG. 4 is a diagram showing the operation of the heat caulking device that is used in the lens fixation method of the embodiment of the invention.

FIG. 5A is a schematic diagram showing an aspect of the deformation of a heat caulking piece-like portion in the lens fixation method of the embodiment of the invention.

FIG. 5B is a schematic diagram showing an aspect of the deformation of the heat caulking piece-like portion in the lens fixation method of the embodiment of the invention.

FIG. 5C is a schematic diagram showing an aspect of the deformation of the heat caulking piece-like portion in the lens fixation method of the embodiment of the invention.

FIG. 6 is a schematic diagram showing a numerical simulation result of the deformation of the heat caulking piece-like portion caused by the lens fixation method of the embodiment of the invention.

FIG. 7 is a schematic diagram showing a numerical simulation result of the deformation of a heat caulking piece-like portion caused by a lens fixation method of Comparative Example.

FIG. 8 is a schematic diagram showing the action of the lens fixation method of Comparative Example.

### DETAILED DESCRIPTION OF THE INVENTION

An embodiment of the invention will be described below with reference to the accompanying drawings.

The structure of a heat caulking device 50 (lens fixation device) used in a lens fixation method of an embodiment of the present invention will be described.

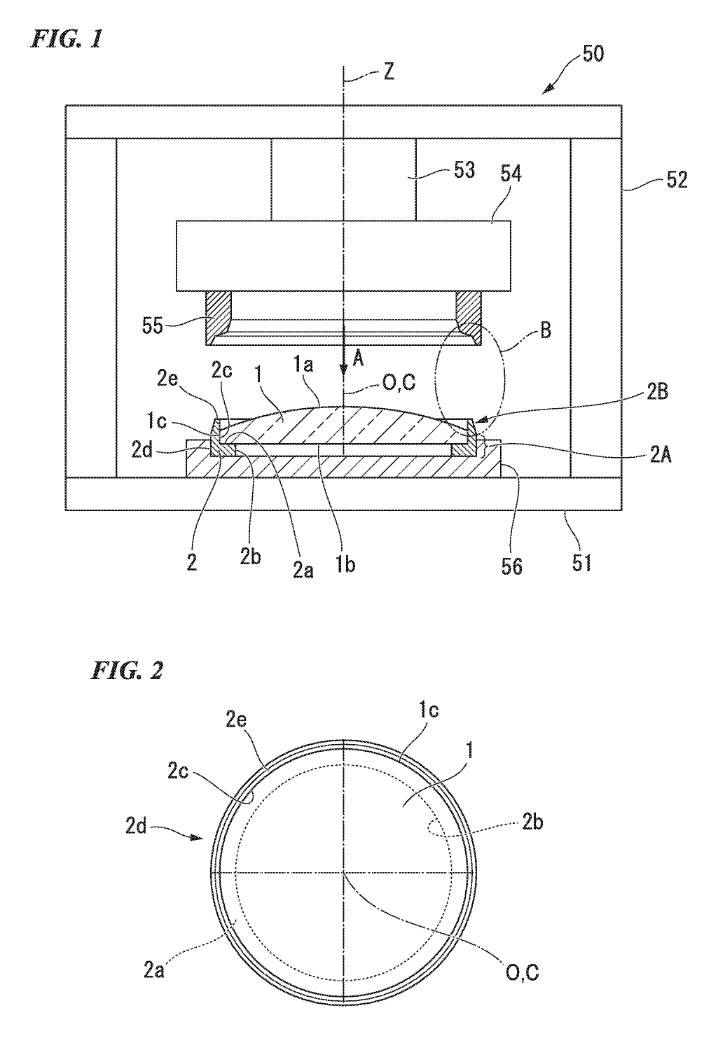

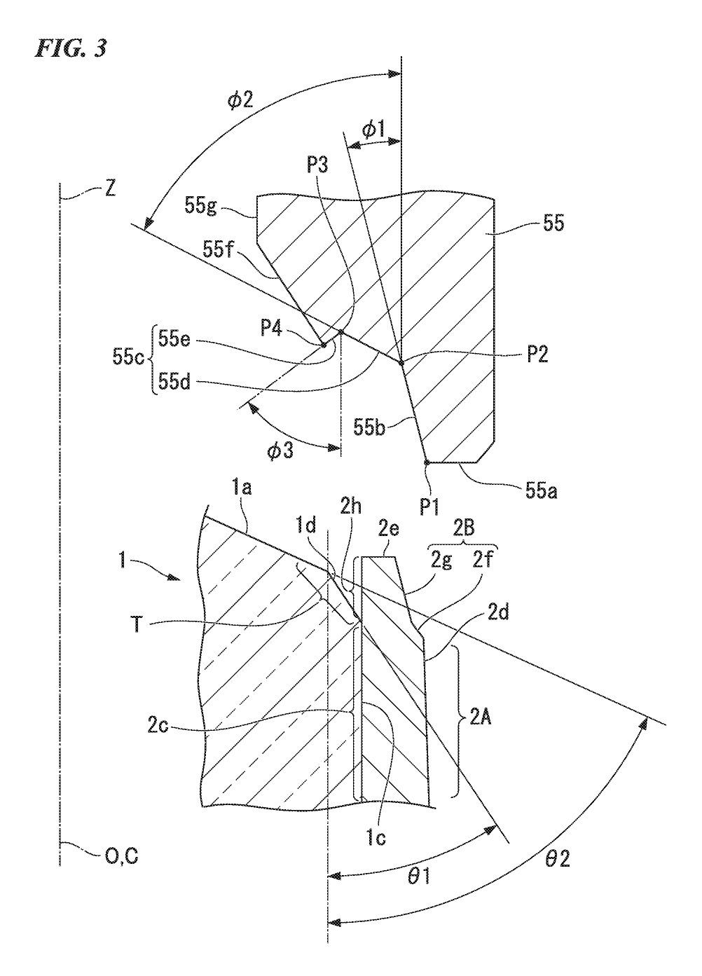

FIG. 1 is a schematic longitudinal sectional view showing an example of the heat caulking device that is used in the lens fixation method of the embodiment of the present invention. FIG. 2 is a view seen in the direction of an arrow A of FIG. 1. FIG. 3 is an enlarged view of a portion B of FIG. 1.

As shown in FIG. 1, the heat caulking device 50 includes a lens frame holder 56, a support part 52, a pressing unit 53, a heating unit 54, and a horn part 55 (heat caulking tool) that are provided on a base 51 supporting the entire device. Although not shown, the heat caulking device 50 includes an operation unit that operates the heat caulking device 50 and a control unit, which controls the operation of the pressing unit 53 and the operation of the heating unit 54 on the basis of the input of the operation of the operation unit, in addition to these components.

The lens frame holder 56 is a part of the device that holds a lens frame 2 into which a lens 1 is inserted. The lens frame holder 56 holds the lens frame 2 such that a heat caulking piece-like portion 2B of the lens frame 2 faces up.

A holding central axis of the lens frame holder 56 is coaxial with a reference axis Z that extends in a vertical direction of the heat caulking device 50.

In a case in which a position relative to a member, such as a shaft-like member or a cylindrical member, of which an axis, such as an optical axis or a central axis, can be specified will be described in this specification, an axial direction, a circumferential direction, and a radial direction may be used. The axial direction is a direction along an axis. The circumferential direction is a direction around an axis. The radial direction is a direction along a line that crosses an axis in a plane orthogonal to the axis.

Particularly, there is a case where a direction along an optical axis is referred to as the direction of an optical axis. There is a case where a side, which is away from an axis with respect to a reference position in the radial direction, is referred to as the outside in the radial direction. Likewise, there is a case where a side closer to an axis is referred to as the inside in the radial direction.

Here, an example of the structure including the lens 1 and the lens frame 2 that fixes the lens 1 will be described.

As shown in FIGS. 1 and 2, the lens 1 includes a first lens surface 1a and a second lens surface 1b. A lens side surface 1c, which is a cylindrical surface coaxial with an optical axis O, is formed on the outer peripheral portion between the first lens surface 1a and the second lens surface 1b.

The shapes of the first lens surface 1a and the second lens surface 1b are not particularly limited. The shapes of each of the first lens surface 1a and the second lens surface 1b may be, for example, the shape of an appropriate surface, such as a spherical surface, an aspherical surface, an adjustable surface, or a flat surface. The shapes of each of the first lens surface 1a and the second lens surface 1b may be any one of a convex surface, a flat surface, and a concave surface.

In the following description, the lens 1 is, for example, a plano-convex lens that includes the first lens surface 1a formed of a convex spherical surface and the second lens surface 1b formed of a flat surface.

As shown in FIG. 3, a chamfered portion 1d is formed at a corner that is adjacent to the first lens surface 1a and the lens side surface 1c. The chamfered portion 1d is a tapered surface that is inclined with respect to the optical axis O by an angle θ1 (here, θ1 is an acute angle) in a cross-section including the optical axis O. In a case in which the inclination of a tangent to the outer edge portion of the first lens surface 1a is denoted by θ2, θ1 is smaller than θ2.

In this embodiment, for example, a portion of the first lens surface 1a positioned outside an effective lens region and the chamfered portion 1d are a caulking region T that can be subjected to heat caulking. The angle of the average inclination of the first lens surface 1a in the caulking region T is about θ2.

However, the shape of the caulking region T is not limited the above-mentioned shape.

For example, the caulking region T may be formed of only the chamfered portion 1d.

For example, in the lens 1, a round portion, which is rounded in the form of an R surface or the like, may be formed between the first lens surface 1a and the lens side surface 1c instead of the chamfered portion 1d. In this case, the round portion and the outer peripheral portion of the first lens surface 1a, or only the round portion may form the caulking region T.

For example, the lens 1 may be provided with a corner where the first lens surface 1a and the lens side surface 1c cross each other without being provided with the chamfered portion 1d and the round portion. In this case, a portion of the first lens surface 1a outside the effective lens region is the caulking region T.

For example, the caulking region T may be formed in a shape other than the shapes of the chamfered portion and the round portion. For example, the caulking region T may be formed in the shape of a flat surface that is orthogonal to the optical axis O, or the like.

For example, in a case in which the lens 1 includes a flange portion, the caulking region T may be formed of the surface of the flange portion.

As long as the material of the lens 1 can be subjected to heat caulking, the material of the lens 1 may be glass or a synthetic resin. The type of a glass lens may be a polished lens or a glass molded lens.

The lens frame 2, which is not yet subjected to heat caulking, is shown in FIGS. 1 and 2. The lens 1 is put in the lens frame 2 that is not yet subjected to heat caulking. The lens frame 2 is a member to which the lens 1 is fixed due to heat caulking performed by the lens fixation method of this embodiment to be described later.

The shape of the lens frame 2, which is not yet subjected to heat caulking, will be described below.

The lens frame 2 is a substantially cylindrical member. The lens frame 2 includes a frame body 2A and a heat caulking piece-like portion 2B that is formed at one end portion (upper end portion shown in FIG. 1) of the frame body 2A. The lens frame 2 is made of a thermoplastic synthetic resin that can be subjected to heat caulking.

A method of manufacturing the lens frame 2 may use resin molding or may use cutting.

In a case in which the lens frame 2 is to be manufactured by resin molding, an appropriate draft is given according to the structure of a mold. A draft required for molding is ignored for simplification in the following description as long as not particularly mentioned. For example, “the shape of a cylindrical surface” also includes a shape that is exactly called the shape of a conical surface since a draft is given.

Hereinafter, for simplification, there is a case where the shape of the lens frame 2 may be described on the basis of the posture of the lens frame 2 disposed in the lens frame holder 56. For example, in regard to the relative position in the axial direction of the lens frame 2, there is a case where a position near the heat caulking piece-like portion 2B is referred to as an upper side or an upper portion and a position opposite thereto is referred to as a lower side or a lower portion.

The frame body 2A is a substantially cylindrical member as a whole. An insertion hole including an inner peripheral surface 2c is formed at the central portion of the frame body 2A. The lens 1 is inserted into the inner peripheral surface 2c.

The optical axis O of the lens 1, which is inserted into the inner peripheral surface 2c, is disposed substantially coaxially with a central axis C of the inner peripheral surface 2c. A distance between the optical axis O and the central axis C in the radial direction is in an eccentrically allowable range of an optical unit that is an assembly. For simplification, the optical axis O and the central axis C will be described as the same axis below.

A lens receiving portion 2a is formed at an end portion (a lower end portion shown in FIG. 1) of the frame body 2A opposite to the heat caulking piece-like portion 2B in the axial direction. The lens receiving portion 2a extends from the inner peripheral surface 2c inward toward the central axis C.

As shown in FIG. 3, the height of the inner peripheral surface 2c is substantially the same as the height of the end portion of the lens side surface 1c of the lens 1, which is put in the lens frame 2, near the chamfered portion 1d.

As shown in FIGS. 1 and 2, the lens receiving portion 2a supports the second lens surface 1b of the lens 1 in the direction of the optical axis. A through-hole 2b is formed at the central portion of the lens receiving portion 2a so as to pass through the lens receiving portion 2a in the axial direction. The through-hole 2b is a cylindrical hole that has a diameter smaller than the outer diameter of the lens 1 and larger than the lens effective diameter of the second lens surface 1b.

The heat caulking piece-like portion 2B of this embodiment is a cylindrical piece-like portion that protrudes from the upper end portion of the frame body 2A.

However, the heat caulking piece-like portion 2B may be formed of a plurality of protrusions, such as protruding pieces, having a cross-sectional structure to be described below. In this case, the plurality of protrusions protrude from a plurality of positions, which are spaced from each other in the circumferential direction, on the upper end portion of the frame body 2A. In a case in which the heat caulking piece-like portion 2B is formed of the plurality of protrusions, the plurality of protrusions may be arranged on the upper end portion of the frame body 2A at a position where the frame body is divided into equal parts in the circumferential direction.

As shown in FIG. 3, the outer shape of the heat caulking piece-like portion 2B of this embodiment is formed by a piece-like portion-inner peripheral surface 2h, a distal end surface 2e, a second piece-like portion-outer peripheral surface 2g, and a first piece-like portion-outer peripheral surface 2f.

The piece-like portion-inner peripheral surface 2h is a cylindrical surface that extends upward along the inner peripheral surface 2c of the frame body 2A. However, for a reduction in the thickness of the distal end of the heat caulking piece-like portion 2B in the radial direction, the piece-like portion-inner peripheral surface 2h may be formed in a tapered shape where a diameter is increased upward.

The distal end surface 2e is formed of a flat surface that is orthogonal to the central axis C. The distal end surface 2e is positioned above the lower end portion of the caulking region T of the lens 1 put in the lens frame 2.

The second piece-like portion-outer peripheral surface 2g is the outer peripheral surface of the heat caulking piece-like portion 2B that is close to the distal end (upper end) in a protruding direction. In this embodiment, the second piece-like portion-outer peripheral surface 2g is inclined radially inward (so as to approach the central axis C) toward the distal end from a proximal end. That is, the second piece-like portion-outer peripheral surface 2g is formed of a tapered surface of which the diameter is reduced toward the distal end from the proximal end.

However, the second piece-like portion-outer peripheral surface 2g may be parallel to the central axis C.

The first piece-like portion-outer peripheral surface 2f is the outer peripheral surface of the heat caulking piece-like portion 2B that is close to the proximal end (lower end) in the protruding direction. In this embodiment, the first piece-like portion-outer peripheral surface 2f is inclined radially outward (so as to be away from the central axis C) toward the proximal end from the distal end. That is, the first piece-like portion-outer peripheral surface 2f is formed of a tapered surface of which the diameter is increased toward a side, which is closer to the proximal end, toward the proximal end side from the proximal end of the second piece-like portion-outer peripheral surface 2g.

The proximal end portion of the first piece-like portion-outer peripheral surface 2f may be positioned on the upper end face of the frame body 2A. However, for example, the proximal end portion of the first piece-like portion-outer peripheral surface 2f is connected to an outer peripheral surface 2d of the frame body 2A in this embodiment.

Due to this structure, the thickness of the heat caulking piece-like portion 2B of this embodiment is continuously reduced toward the distal end side from the thickness of the distal end portion of the frame body 2A in the radial direction. The heat caulking piece-like portion 2B of this embodiment is a cylindrical piece-like body.

The first piece-like portion-outer peripheral surface 2f of the outer peripheral portion of the heat caulking piece-like portion 2B forms a stepped portion that is inclined with respect to the outer peripheral surface 2d of the frame body 2A. The first piece-like portion-outer peripheral surface 2f and the second piece-like portion-outer peripheral surface 2g of the heat caulking piece-like portion 2B are small-diameter portions that are dented radially inward from the outer peripheral surface 2d of the frame body 2A.

Here, description returns to the description of the heat caulking device 50.

As shown in FIG. 1, the support part 52 is a part of the device that disposes the pressing unit 53, the heating unit 54, and the horn part 55 to be described later above the lens frame holder 56.

The pressing unit 53 is a part of the device that generates a pressing force for pressing the heat caulking piece-like portion 2B. The pressing unit 53 includes a motor (not shown) as a drive source.

The upper end portion of the pressing unit 53 is supported by the support part 52. The heating unit 54 to be described later is connected to the lower end portion of the pressing unit 53.

The lower end portion of the pressing unit 53 can be advanced and retracted along the reference axis Z by a drive source (not shown).

The heating unit 54 is a part of the device that is used to heat the heat caulking piece-like portion 2B through the horn part 55 to be described later. The upper portion of the heating unit 54 is fixed to the lower end portion of the pressing unit 53. The heating unit 54 is supported by the pressing unit 53 so as to be movable along the reference axis Z. The horn part 55 to be described later is fixed to the lower surface of the heating unit 54.

As the specific structure of the heating unit 54, an appropriate unit structure may be employed according to a method of heat caulking.

For example, in a case in which heat caulking is performed by heating the horn part 55, the heating unit 54 includes a heater (not shown).

For example, in a case in which heat caulking is performed by applying ultrasonic vibration to the horn part 55, the heating unit 54 includes an ultrasonic vibrator (not shown).

For example, the heating unit 54 may include a heater in addition to an ultrasonic vibrator.

For example, the heating unit 54 includes a heater in the following description.

The horn part 55 can heat and press the heat caulking piece-like portion 2B of the lens frame 2. The horn part 55 softens and bends the heat caulking piece-like portion 2B, and shapes the outer shape of the heat caulking piece-like portion 2B into the shape of a caulked portion 2C to be described later.

In this embodiment, the horn part 55 is formed of a substantially cylindrical metal member. The horn part 55 is fixed to the lower portion of the heating unit 54 such that the central axis of the horn part 55 is coaxial with the reference axis Z.

As shown in FIG. 3, an annular distal end surface 55a, which has a center on the reference axis Z, is formed at the lower end portion of the horn part 55. The distal end surface 55a forms a third angle that is larger than a first angle formed between a first pressing portion 55b to be described later and the reference axis Z. In this embodiment, the distal end surface 55a is, for example, a flat surface that is orthogonal to the reference axis Z. In this embodiment, the third angle is 90°.

The inner diameter of the distal end surface 55a is equal to or smaller than the outer diameter of the upper end portion of the frame body 2A.

A first pressing portion 55b, a second pressing portion 55c, and a relief portion 55f are formed on the inner side of the horn part 55 facing the reference axis Z in this order from the inner edge portion of the distal end surface 55a. The first pressing portion 55b, the second pressing portion 55c, and the relief portion 55f are formed in concentric regions having a center on the reference axis Z.

Each of the first pressing portion 55b, the second pressing portion 55c, and the relief portion 55f has a shape symmetrical with respect to the reference axis Z in this embodiment.

The first pressing portion 55b is a portion of the horn part 55 pressing the outer peripheral portion of the heat caulking piece-like portion 2B such that the heat caulking piece-like portion 2B is inclined toward the inner peripheral side.

The first pressing portion 55b is formed of a first tapered surface of which the diameter is reduced inward toward the upper side from the inner edge portion of the distal end surface 55a that is shown by a point P1. The first pressing portion 55b is inclined with respect to the reference axis Z by an angle φ1 (first angle) in a cross-section including the reference axis Z.

The angle φ1 is an angle at which a component of a force, which faces radially inward, of the first pressing portion 55b pressing the heat caulking piece-like portion 2B is larger than a component of a force, which is parallel to the reference axis Z, of the first pressing portion 55b pressing the heat caulking piece-like portion 2B in a case in which the first pressing portion 55b is pressed against the heat caulking piece-like portion 2B by being moved along the reference axis Z. Specifically, φ1 is larger than 0° and smaller than 45°. It is more preferable that φ1 is smaller than the inclination angle of the outer peripheral side of the caulking region T of the lens 1.

In addition, the first pressing portion 55b is formed in a shape where the first pressing portion 55b comes into contact with the proximal end portion of the heat caulking piece-like portion 2B before the horn part 55 comes into contact with the distal end portion of the heat caulking piece-like portion 2B of the lens frame 2 disposed coaxially with the reference axis Z in a case in which the first pressing portion 55b is moved downward along the reference axis Z as described later.

In the case of this embodiment, the inclination angle φ1 of the first pressing portion 55b and the length of the first pressing portion 55b are set such that the first pressing portion 55b is not in contact with the distal end portion of the heat caulking piece-like portion 2B in a case in which a state in which the point P1 is in contact with the first piece-like portion-outer peripheral surface 2f by the downward movement of the horn part 55 is made. Since the second pressing portion 55c is disposed above the upper end (see a point P2 of FIG. 3) of the first pressing portion 55b in this embodiment as described later, the second pressing portion 55c is also spaced apart from the distal end portion of the heat caulking piece-like portion 2B.

The first pressing portion 55b may or may not be in contact with the distal end portion of the heat caulking piece-like portion 2B, which is not yet deformed, in a case in which the horn part 55 is further moved downward.

Examples of such setting, for example, includes setting (Setting Example 1) where the first pressing portion 55b is parallel to the second piece-like portion-outer peripheral surface 2g and the length of the first pressing portion 55b between the point P1 of the lower end and the point P2 of the upper end of the first pressing portion 55b in the axial direction is longer than a total length of the first piece-like portion-outer peripheral surface 2f and the second piece-like portion-outer peripheral surface 2g in the axial direction.

As setting other than Setting Example 1, there is, for example, a case where the position of the point P2 of Setting Example 1 may be set to be lower depending on the inclination of an upper surface-forming portion 55d of the second pressing portion 55c to be described later. That is, setting (Setting Example 2) where the length of the first pressing portion 55b between the point P1 of the lower end and the point P2 of the upper end of the first pressing portion 55b in the axial direction is equal to or shorter than a total length of the first piece-like portion-outer peripheral surface 2f and the second piece-like portion-outer peripheral surface 2g in the axial direction in Setting Example 1 may be used.

For example, setting (Setting Example 3) where the inclination of the second piece-like portion-outer peripheral surface 2g is smaller than the inclination of the first pressing portion 55b in Setting Example 1 may be used depending on the inclination of an upper surface-forming portion 55d of the second pressing portion 55c to be described later.

For example, setting (Setting Example 4) where the inclination of the second piece-like portion-outer peripheral surface 2g is larger than the inclination of the first pressing portion 55b in Setting Example 1 may be used.

A description will be provided below on the basis of Setting Example 1 by way of example.

The second pressing portion 55c is a portion of the horn part 55 that is closer to the proximal end (upper end) than the first pressing portion 55b and presses the heat caulking piece-like portion 2B in the axial direction of the lens frame 2 toward the caulking region T.

In this embodiment, the second pressing portion 55c includes an upper surface-forming portion 55d and an inner peripheral surface-forming portion 55e.

The upper surface-forming portion 55d is formed of a second tapered surface of which the diameter is reduced inward toward the upper side from the upper end portion of the first pressing portion 55b that is shown by the point P2. The upper surface-forming portion 55d is inclined with respect to the reference axis Z by an angle (p2 (second angle, here φ2>φ1) in a cross-section including the reference axis Z.

The magnitude of the angle φ2 is not particularly limited as long as a caulked portion 2C to be described later can be formed by the upper surface-forming portion 55d so as to have a thickness where required strength is ensured.

For example, the angle φ2 may be an acute angle, a right angle, and an obtuse angle in a case in which the inclination angle of the caulking region T of the lens 1, which is put in the lens frame 2 so as to be coaxial with the reference axis Z, is an acute angle, a right angle, and an obtuse angle, respectively.

For example, in a case in which the inclination angle of the caulking region T is an acute angle as shown in FIG. 3, the angle φ2 may be 90° or less. In this case, it is difficult for the heat caulking piece-like portion 2B, which is to be deformed when being pressed, to be released toward the upper side of the radial outside.

For example, in a case in which the inclination angle of the caulking region T in an inner peripheral region is different from that in the outer peripheral region, the angle φ2 may be set to an angle equal to or larger than the inclination angle in the inner peripheral region. For example, φ2 may satisfy “φ2≥θ2” in an example shown in FIG. 3. In this case, since the thickness of the outer peripheral portion of the caulked portion 2C to be described later, which is formed by the horn part 55, is increased, the caulking strength can be increased.

The inner peripheral surface-forming portion 55e is a pressing portion that suppresses the deformation of the heat caulking piece-like portion 2B. The inner peripheral surface-forming portion 55e allows the deformed heat caulking piece-like portion 2B, which is moved along the caulking region T by being pressed in the axial direction by the upper surface-forming portion 55d, not to enter the effective lens region of the first lens surface 1a. The inner peripheral surface-forming portion 55e regulates the length of a portion of the caulked portion 2C to be described later that protrudes to the inner peripheral side.

The inner peripheral surface-forming portion 55e is formed of a third tapered surface of which the diameter is reduced inward toward the lower side from the inner edge portion of the upper surface-forming portion 55d that is shown by a point P3.

The radial position of the lower end edge of the inner peripheral surface-forming portion 55e, which is shown by a point P4, is present outside the effective lens region of the first lens surface 1a of the lens 1 that is put in the lens frame 2.

The axial position of the lower end edge of the inner peripheral surface-forming portion 55e can be determined according to a thickness required for the distal end portion of the caulked portion 2C to be described later.

The inclination angle of the inner peripheral surface-forming portion 55e with respect to the reference axis Z is an angle φ3. The magnitude of the angle φ3 may be selected in the range of 0° to 90° in the case of this embodiment. The magnitude of the angle φ3 may be in the range of, for example, (90°-φ2)±20° so as to be close to the inclination of a normal line to the upper surface-forming portion 55d.

The relief portion 55f is the inner peripheral surface of the horn part 55 that is closer to the radially inner side than the inner peripheral surface-forming portion 55e. The relief portion 55f forms a hole portion preventing the horn part 55 from coming into contact with a portion of the first lens surface 1a, which is closer to the inner peripheral side than the lower end edge of the inner peripheral surface-forming portion 55e, in a case in which the lower end edge of the inner peripheral surface-forming portion 55e is close to the lens receiving portion 2a.

The relief portion 55f is formed of a tapered surface of which the diameter is reduced inward toward the upper side from the inner edge portion of the inner peripheral surface-forming portion 55e that is shown by a point P4. A cylindrical surface 55g, which extends along the reference axis Z, is connected to the upper end portion of the relief portion 55f.

Next, a lens fixation method of this embodiment, which can be performed using the heat caulking device 50 having this structure, will be described.

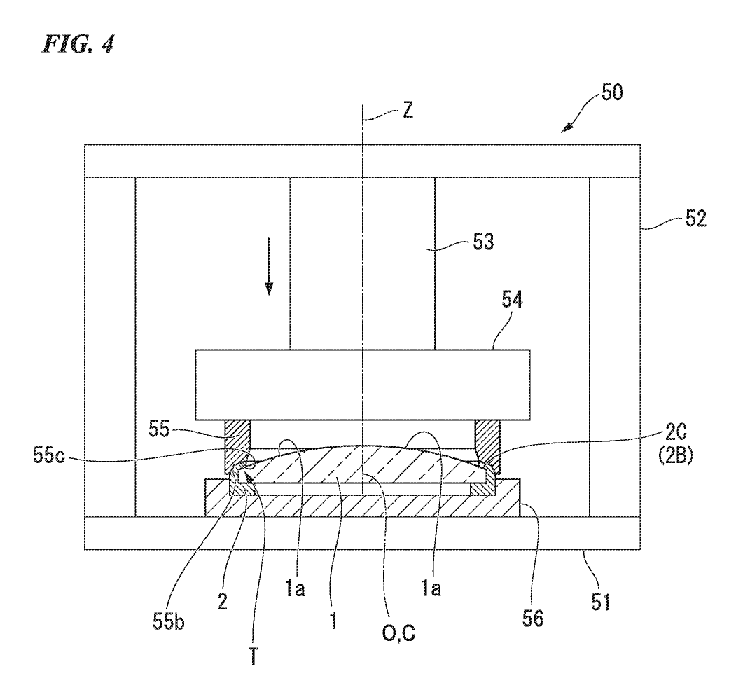

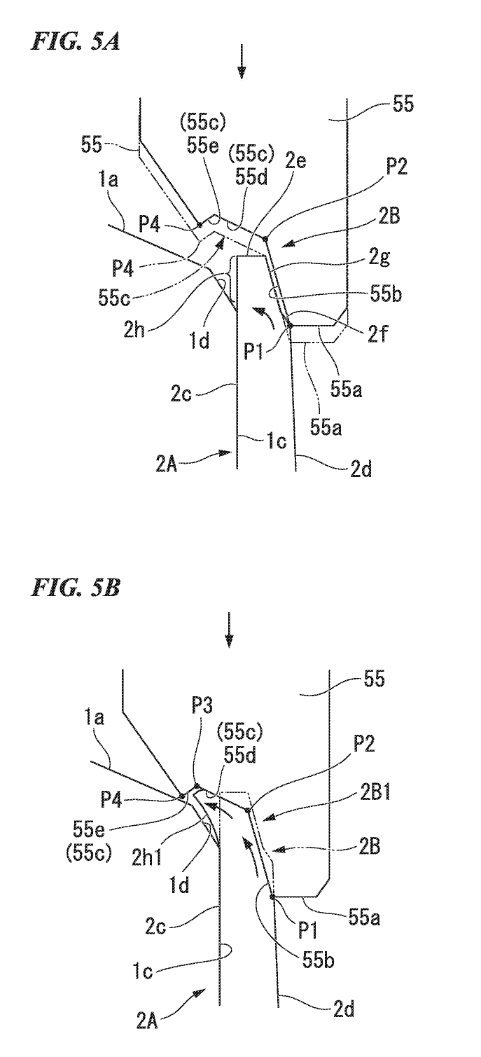

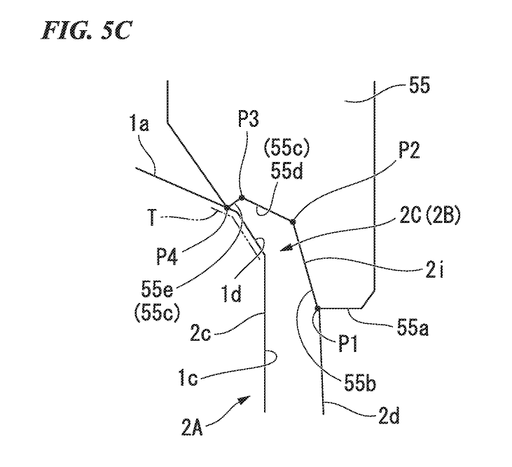

FIG. 4 is a diagram showing the operation of the heat caulking device that is used in the lens fixation method of the embodiment of the present invention. FIGS. 5A, 5B, and SC are schematic diagrams showing aspects of the deformation of the heat caulking piece-like portion in the lens fixation method of the embodiment of the present invention.

The lens fixation method of this embodiment is a method of fixing a lens to a lens frame by putting the lens in the lens frame on which a heat caulking piece-like portion is formed and pressing a heat caulking tool against the heat caulking piece-like portion to perform heat caulking.

In this embodiment, operations including at least a first operation, a second operation, and a third operation to be described below are performed in a case in which the heat caulking tool is to be pressed against the heat caulking piece-like portion.

The first operation is to allow a first pressing portion, which is close to the distal end of the heat caulking tool, to come into contact with the proximal end portion of the heat caulking piece-like portion before the heat caulking tool comes into contact with the distal end portion of the heat caulking piece-like portion.

The second operation is to press the outer peripheral portion of the heat caulking piece-like portion by the first pressing portion such that the heat caulking piece-like portion is inclined toward the inner peripheral side after the first pressing portion comes into contact with the heat caulking piece-like portion.

The third operation is to press the distal end portion of the heat caulking piece-like portion toward the caulking region, which is provided on the lens, in the axial direction of the lens frame by a second pressing portion, which is closer to the proximal end than the first pressing portion in the heat caulking piece-like portion, in a state in which the first pressing portion is in contact with the heat caulking piece-like portion.

An example of the lens fixation method of this embodiment will be described below using an example of a case in which the lens 1 is heat caulked on the lens frame 2 by the heat caulking device 50.

First, as shown in FIG. 1, the lens frame 2 into which the lens 1 is inserted is fixed to the lens frame holder 56. In this case, the lens frame 2 is positioned such that the central axis C is coaxial with the reference axis Z of the heat caulking device 50.

In such a positional relationship, the first pressing portion 55b and the second pressing portion 55c of the distal end portion of the horn part 55 are disposed so as to be coaxial with the central axis C.

Then, the control unit of the heat caulking device 50 heats the horn part 55 by the heating unit 54. The temperature of the horn part 55 is set to a heating temperature at which at least the heat caulking piece-like portion 2B being in contact with the horn part 55 is softened. The heating temperature may be a temperature at which the heat caulking piece-like portion 2B can be deformed by the pressing force of the pressing unit 53. The heating temperature may be determined according to the characteristics of the resin material of the heat caulking piece-like portion 2B.

After that, as shown in FIG. 4, the control unit of the heat caulking device 50 drives the pressing unit 53 to move down the horn part 55. The heat caulking piece-like portion 2B is subjected to heat caulking by the horn part 55. In this case, the control unit of the heat caulking device 50 stops driving the pressing unit 53 after moving down the horn part 55 to an appropriate position. For example, the control unit determines the appropriate position of the horn part 55 by detecting at least one of the position to which the horn part 55 is moved down and a reaction force that is applied to the horn part 55 and comparing the detected result with a determination value that is stored in advance.

In a state in which the pressing unit 53 stops, the heat caulking piece-like portion 2B is pressed by the first pressing portion 55b and the second pressing portion 55c while being heated. Accordingly, the heat caulking piece-like portion 2B is in close contact with the caulking region T provided on the lens 1. As a result, the caulked portion 2C, of which the upper surface is deformed along the shapes of the first pressing portion 55b and the second pressing portion 55c, is formed. Detailed processes in this case will be described later.

After the caulked portion 2C is formed, the control unit of the heat caulking device 50 drives the pressing unit 53 to move up the horn part 55.

Heat caulking performed by the heat caulking device 50 ends as described above. The lens 1 is fixed to the lens frame 2 by the caulked portion 2C.

Detailed operations and actions of the heat caulking operation of the horn part 55 will be described.

As shown in FIG. 5A by a solid line, in a case in which the horn part 55 is moved down, the first pressing portion 55b, which is close to the distal end of the horn part 55, comes into contact with the proximal end portion of the heat caulking piece-like portion 2B before coming into contact with the distal end portion of the heat caulking piece-like portion 2B (first operation). Specifically, the point P1 of the distal end of the first pressing portion 55b comes into contact with the lower end portion of the first piece-like portion-outer peripheral surface 2f, and the distal end portion of the heat caulking piece-like portion 2B is spaced apart from the first pressing portion 55b and the second pressing portion 55c.

Since the inner diameter of the distal end of the first pressing portion 55b is equal to or smaller than the outer diameter of the proximal end portion of the first piece-like portion-outer peripheral surface 2f, the above-mentioned first operation is performed by the downward movement of the horn part 55 that is disposed so as to be coaxial with the lens frame 2.

After that, for example, as shown in FIG. 5B by a two-dot chain line, in a case in which the horn part 55 is further moved down, the distal end of the first pressing portion 55b is moved along the reference axis Z so as to slide on the outer peripheral surface 2d of the frame body 2A. In this case, the first piece-like portion-outer peripheral surface 2f is pressed in the direction of a normal line to the first pressing portion 55b first by the downward movement of the first pressing portion 55b.

Since the heat caulking piece-like portion 2B of the first piece-like portion-outer peripheral surface 2f is interposed between the lens side surface 1c of the lens 1 and the first pressing portion 55b, the heat caulking piece-like portion 2B is gradually pressed and crushed in the radial direction. In this case, the distal end of the first pressing portion 55b, which is a portion coming into contact with the heat caulking piece-like portion 2B, is gradually moved down. When viewed from the first pressing portion 55b, the pressed and crushed resin material is relatively pressed and elongated to the proximal end side along the inclined surface of the first pressing portion 55b.

The distal end portion of the first pressing portion 55b, which is in contact with the outer peripheral portion of the heat caulking piece-like portion 2B, gradually comes into contact with the frame body 2A. The frame body 2A has a temperature lower than the temperature of the heat caulking piece-like portion 2B, and has a thickness larger than the thickness of the heat caulking piece-like portion 2B. The pressed and crushed resin material is not moved to the distal end side in comparison with the distal end surface 55a. As a result, the distal end portion of the first pressing portion 55b acts to seal the pressed and crushed resin material in the radial direction.

An operation for moving down the first pressing portion 55b is an operation for drawing the outer peripheral surface of the heat caulking piece-like portion 2B along the first pressing portion 55b.

As the horn part 55 is moved down, a gap between the first pressing portion 55b and the second piece-like portion-outer peripheral surface 2g is gradually reduced. The first pressing portion 55b starts to come into contact with the second piece-like portion-outer peripheral surface 2g from a portion thereof that is closest to the second piece-like portion-outer peripheral surface 2g. The first pressing portion 55b presses the second piece-like portion-outer peripheral surface 2g in the direction of a normal line thereto.

Since the first pressing portion 55b is inclined with respect to the reference axis Z by the acute angle φ1, the radial component of a pressing force acting on the heat caulking piece-like portion 2B from the outer peripheral side is larger than the axial component thereof.

As a result, the heat caulking piece-like portion 2B is pressed inward in the radial direction from the proximal end side as the first pressing portion 55b is moved down.

The lens side surface 1c of the lens 1 is inserted into the frame body 2A. For this reason, even though the frame body 2A is pressed from the outside in the radial direction, the frame body 2A cannot fall inward from the position of the lens side surface 1c. However, in a case in which the heat caulking piece-like portion 2B, which protrudes upward from the lens side surface 1c, is pressed from the outside in the radial direction, the heat caulking piece-like portion 2B falls inward in the radial direction in the range of a gap between the piece-like portion-inner peripheral surface 2h and the chamfered portion 1d.

As a result, in a case in which a portion to be pressed by the first pressing portion 55b is moved toward the distal end side of the heat caulking piece-like portion 2B, the heat caulking piece-like portion 2B is in a deformation mode where the resin material falls down toward the chamfered portion 1d rather than is not press and crush.

For this reason, the heat caulking piece-like portion 2B is inclined along the first pressing portion 55b toward the inner peripheral side from the proximal end portion.

As described above, the above-mentioned second operation is performed in a case in which the distal end of the first pressing portion 55b is further moved down after coming into contact with the proximal end portion of the heat caulking piece-like portion 2B.

In a case in which the second operation starts, a distance between the distal end surface 2e and the second pressing portion 55c in the axial direction is reduced. For this reason, in a case in which the horn part 55 is moved down by a certain distance after the start of the second operation, the upper surface-forming portion 55d of the second pressing portion 55c is moved to the lower side of the undeformed distal end surface 2e (see a two-dot chain line of FIG. 5B) as shown in FIG. 5B. While this movement is performed, the distal end portion of the heat caulking piece-like portion 2B is pressed by the axial movement of the upper surface-forming portion 55d of the second pressing portion 55c.

The pressing force acting on the heat caulking piece-like portion 2B acts in the direction of a normal line to the second pressing portion 55c.

The upper surface-forming portion 55d of the second pressing portion 55c is inclined with respect to the reference axis Z by the angle φ2 larger than the angle φ1. For this reason, a ratio of an axial component to a radial component of a second pressing force, which acts on the heat caulking piece-like portion 2B from the second pressing portion 55c from the upper side, is larger than that of a first pressing force, which acts on the heat caulking piece-like portion 2B from the first pressing portion 55b.

As a result, the heat caulking piece-like portion 2B is pressed toward the caulking region T from the distal end side as the second pressing portion 55c is moved down (third operation).

The third operation is performed in parallel with the second operation. For this reason, as shown in FIG. 5B, the distal end portion of the heat caulking piece-like portion 2B is pressed toward the caulking region T while falling down toward the central axis C around the proximal end portion of the chamfered portion 1d.

In a case in which the third operation proceeds, a gap between a piece-like portion-inner peripheral surface 2h1, which is deformed from the piece-like portion-inner peripheral surface 2h, and the chamfered portion 1d is gradually narrowed from the proximal end side of the piece-like portion-inner peripheral surface 2h1. The piece-like portion-inner peripheral surface 2h1 gradually comes into close contact with the chamfered portion 1d from the proximal end side.

As shown in FIG. 5C, the deformed heat caulking piece-like portion 2B is pressed by the first pressing portion 55b, the upper surface-forming portion 55d, and the inner peripheral surface-forming portion 55e in a case in which the downward movement of the horn part 55 is stopped. The caulked portion 2C, which is in close contact with the caulking region T, is formed on the caulking region T that is formed of the chamfered portion 1d and the outer peripheral portion of the first lens surface 1a.

A tapered side caulked surface 2i, which is deformed from the second pressing portion 55c in a case in which the second pressing portion 55c is pressed, is formed on the caulked portion 2C at the upper end portion of the frame body 2A. In this embodiment, the side caulked surface 2i is formed so as to be opposite to a part of the lens side surface 1c of the fixed lens 1 in the radial direction.

The distal end portion of the caulked portion 2C is sealed by the inner peripheral surface-forming portion 55e that is close to the first lens surface 1a. For this reason, the extension of the burr of the caulked portion 2C into the effective lens region is prevented.

The proximal end portion of the caulked portion 2C is sealed by the distal end portion of the first pressing portion 55b. The resin material, which flows due to deformation, does not leak from the distal end portion of the first pressing portion 55b. As a result, a resin material necessary for the formation of the caulked portion 2C does not lack.

As described above, the heat caulking piece-like portion 2B1, which is being deformed, receives a large component of a force from the entire first pressing portion 55b in the radial direction by the second operation while sliding along the first pressing portion 55b. The heat caulking piece-like portion 2B1 is bent along the inclination of the first pressing portion 55b from the proximal end portion.

For this reason, resin fluidity, which is required in a case in which the heat caulking piece-like portion 2B1 is pressed and crushed in the thickness direction so as to be plastically deformed, is not required in the second operation. For example, even though the temperature of the heat caulking piece-like portion 2B1 is low due to a variation in heating temperature, it is easy to deform the heat caulking piece-like portion 2B1 by a pressing force. For this reason, even though the fluidity of a resin material is low due to a variation in heating temperature, it is difficult for the poor close contact of the caulked portion to be caused.

The action of the lens fixation method of this embodiment will be described on the basis of an example of a numerical simulation.

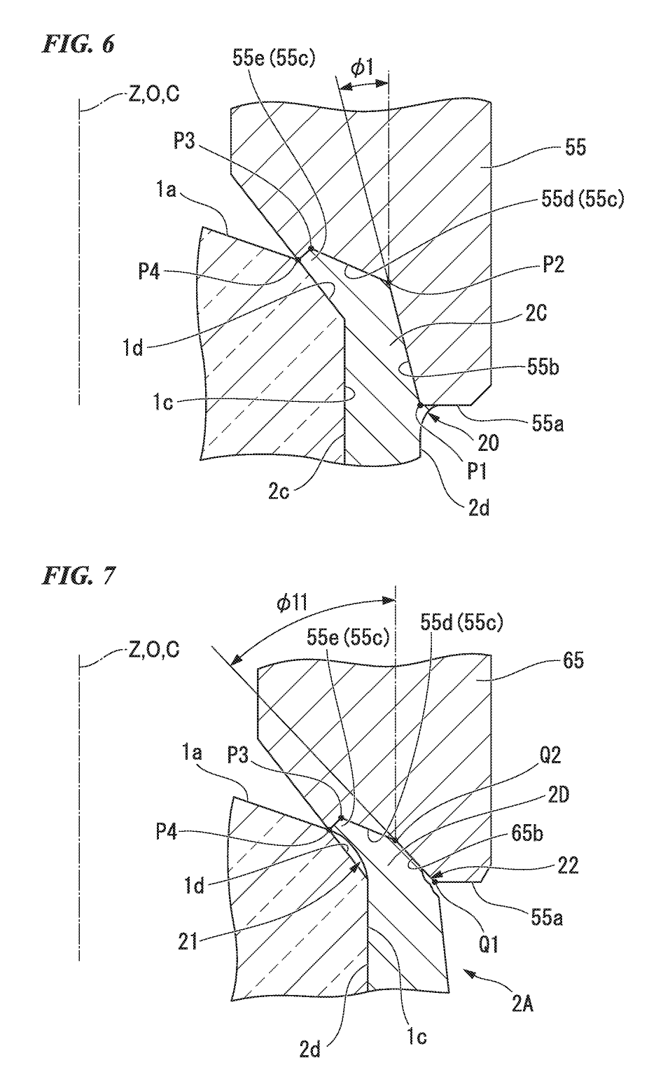

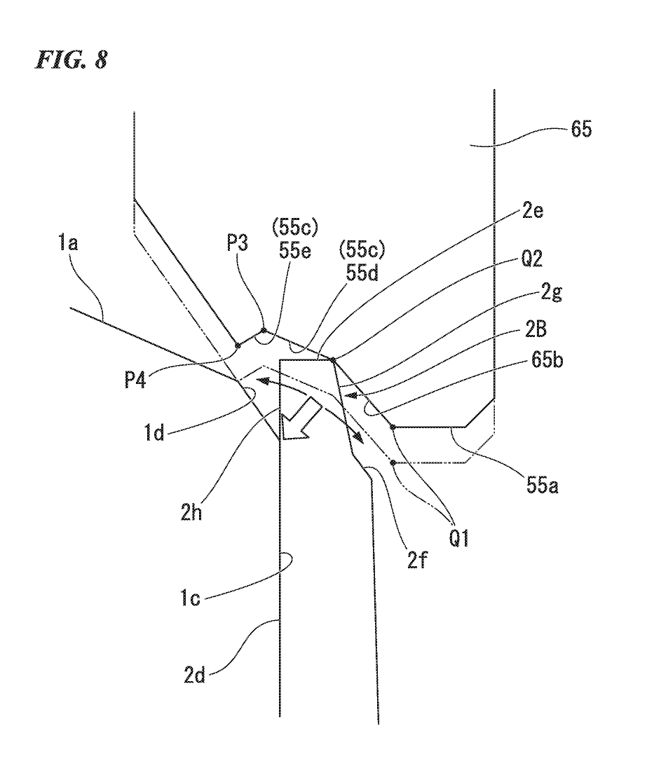

FIG. 6 is a schematic diagram showing a numerical simulation result of the deformation of the heat caulking piece-like portion caused by the lens fixation method of the embodiment of the present invention. FIG. 7 is a schematic diagram showing a numerical simulation result of the deformation of a heat caulking piece-like portion caused by a lens fixation method of Comparative Example. FIG. 8 is a schematic diagram showing the action of the lens fixation method of Comparative Example.

FIG. 6 shows Example of a numerical simulation result based on the above-mentioned embodiment. Example is different from the above-mentioned embodiment in that the lower end edge (see the point P4) of the inner peripheral surface-forming portion 55e is in contact with a boundary between the first lens surface 1a and the chamfered portion 1d.

The inclination angle φ1 of the first pressing portion 55b was set to 15°.

A numerical simulation result representing that the caulked portion 2C of Example is in close contact with the chamfered portion 1d, the second pressing portion 55c, and the first pressing portion 55b was obtained as shown in FIG. 6. However, a burr 20 formed of a resin portion, which was cut from the outer peripheral surface 2d by the distal end surface 55a, was formed at the distal end of the distal end surface 55a. However, in view of the process of the simulation, the burr 20 is not a burr caused by the downward leakage of a resin material that is closer to the distal end than the frame body 2A. Accordingly, it is thought that fixing performance for the lens 1 is not affected even though the burr 20 is formed. Since the burr 20 is away from the first lens surface 1a, machining for removing the burr can be easily performed as necessary.

FIG. 7 shows a numerical simulation result of Comparative Example that uses a horn part 65 having a shape different from that of the above-mentioned embodiment.

Comparative Example shown in FIG. 7 is different from Example in that the length of the upper surface-forming portion 55d of the second pressing portion 55c is shortened and a first pressing portion 65b of which the inclination angle is changed is provided instead of the first pressing portion 55b of Example. The reason why the upper surface-forming portion 55d is to be shortened is that it is difficult to find a difference in an action caused by a change in the inclination angle of the first pressing portion 65b since the contact area between the first pressing portion 65b and the heat caulking piece-like portion 2B is excessively reduced in a case in which the length of the upper surface-forming portion 55d is the same as that of Example.

The inclination angle φ11 of the first pressing portion 65b with respect to the reference axis Z was set to 650.

The inner diameter of the inner edge portion of the distal end surface 55a was set to be the same as that of Example. For this reason, the position of the inner edge portion of the distal end surface 55a of Comparative Example, which is shown by a point Q1, is the same as that of the point P1 in the radial direction, but the position thereof in the axial direction is present above the position of the point P1. Specifically, in a state in which pressing is stopped as shown in FIG. 7, the height of the lower end portion of the chamfered portion 1d is substantially the same as the height of the position of the inner edge portion of the distal end surface 55a.

As shown in FIG. 7, a caulked portion 2D of Comparative Example was formed only on the lateral side of the chamfered portion 1d. A portion of the first pressing portion 65b close to a proximal end side (upper end side shown in FIG. 7) was merely in contact with the caulked portion 2D of Comparative Example. A gap 22 was formed between the surface of the caulked portion 2D and the surface of the first pressing portion 65b on the distal end side (lower end side shown in FIG. 7) of the first pressing portion 65b.

A gap 21 is formed between the chamfered portion 1d and the caulked portion 2D on the lower surface of the caulked portion 2D.

Only the distal end portion of the caulked portion 2D was in contact with the lens 1 in the axial direction. The distal end portion of the caulked portion 2D was in line contact with the lens 1 in an annular shape. For this reason, it is thought that the fixation strength of the lens 1 is significantly low in comparison with the case of the caulked portion 2C of Example.

Consideration of the reason why the caulked portion 2D of Comparative Example cannot be in close contact with the chamfered portion 1d and the first pressing portion 65b will be described with reference to FIG. 8.

As shown in FIG. 8, the distal end portion of the heat caulking piece-like portion 2B comes into contact with a point Q2 that is the boundary between the second pressing portion 55c and the first pressing portion 65b in Comparative Example in a case in which the horn part 65 is moved down as shown by a solid line. In this case, the distal end portion of the first pressing portion 65b is not in contact with the heat caulking piece-like portion 2B.

In a case in which the position of the point Q2 is shifted in the radial direction, the distal end portion of the heat caulking piece-like portion 2B is in contact with the second pressing portion 55c or the first pressing portion 65b. However, even though the heat caulking piece-like portion 2B is in contact with any one of the second pressing portion 55c and the first pressing portion 65b, the distal end portion of the first pressing portion 65b is not in contact with the heat caulking piece-like portion 2B.

Accordingly, in a case in which the horn part 65 is further moved down as shown by a two-dot chain line, the distal end portion of the heat caulking piece-like portion 2B is pressed and crushed in the axial direction by the second pressing portion 55c. In this case, the distal end portion of the heat caulking piece-like portion 2B is pressed and crushed toward the chamfered portion 1d by a pressing force applied in the direction of a normal line to the second pressing portion 55c (see an outlined arrow shown in FIG. 8).

In this case, a resin material to be pressed and crushed can be moved inward and outward in the radial direction along the second pressing portion 55c and the first pressing portion 65b as shown by solid-line arrows shown in FIG. 8. For this reason, the amount of a resin to be moved toward the chamfered portion 1d is reduced in comparison with a case in which a resin material cannot be moved along the first pressing portion 65b.

As a result, it is thought that the gap 21 shown in FIG. 7 is formed.

On the other hand, since the leakage of a resin, which is relieved outward in the radial direction along the solid-line arrow, is not prevented by the first pressing portion 65b, this resin is drawn out to a space that is opened to the outside in the radial direction. Since the resin to be drawn out is not pressed toward the first pressing portion 65b, the resin is solidified in a state in which an irregular surface, such as a corrugated surface, is formed. Accordingly, it is thought that the gap 22 is formed.

It is thought that the caulked portion 2D could not be in close contact with the chamfered portion 1d since the first to third operations of the lens fixation method of this embodiment were not performed in Comparative Example due to a change in the inclination angle of the first pressing portion 65b.

According to the lens fixation method of this embodiment, the first to third operations are performed as described above. Accordingly, adhesion between a caulked portion, which is to be formed by heat caulking, and the lens can be improved.

It has been described in the description of the embodiment that the first pressing portion 55b and the second pressing portion 55c are formed of tapered surfaces having different inclination angles. However, at least one of the first pressing portion 55b and the second pressing portion 55c may be formed of a curved surface.

An example of a case in which only the lens 1 is fixed to the lens frame 2 has been described in the description of the embodiment. However, a plurality of lenses may be fixed to the lens frame. In this case, only some of the plurality of lenses may be fixed using the lens fixation method of this embodiment.

An example of a case in which the heat caulking piece-like portion 2B is formed in the shape of a cylinder continuous in the circumferential direction has been described in the description of the embodiment. However, the structure of the horn part 55 described in the embodiment can be applied even in a case in which the heat caulking piece-like portion 2B is formed of protruding pieces spaced apart from each other in the circumferential direction.

Here, in the case of a certain shape of the protruding pieces of the heat caulking piece-like portion 2B, a plurality of pressing portions may also be provided in the circumferential direction on the horn part so as to correspond to the protruding pieces.

An example of a case in which the outer peripheral surface of the heat caulking piece-like portion 2B is formed of the second piece-like portion-outer peripheral surface 2g and the first piece-like portion-outer peripheral surface 2f has been described in the description of the embodiment. However, other shapes may be employed as the shape of the outer peripheral surface of the heat caulking piece-like portion. The shape of the outer peripheral surface of the heat caulking piece-like portion may be a shape that allows the first pressing portion, which is close to the distal end of the heat caulking tool, to come into contact with the proximal end portion of the heat caulking piece-like portion before the heat caulking tool comes into contact with the distal end portion of the heat caulking piece-like portion. For example, the outer peripheral surface of the heat caulking piece-like portion may be a tapered surface of which the diameter is reduced toward the distal end side from the proximal end side or a curved surface of which a reduction in the diameter is changed.

An example of a case in which the lens frame is made of a synthetic resin has been described in the description of the embodiment. However, as long as a caulking protrusion is made of a thermoplastic synthetic resin, the materials of other portions of the lens frame are not particularly limited. For example, a lens frame in which a frame member made of metal and a resin material forming the caulking protrusion are combined with each other may be used.

The preferred embodiment of the present invention and Example have been described above, but the present invention is not limited to the embodiment and Example. Additions, omissions, substitutions, and other changes of components can be applied without departing from the scope of the present invention.

Further, the present invention is not limited by the foregoing description, and is only limited by the scope of the appended claims.

What is claimed is:

1. A lens fixation method of fixing a lens to a lens frame by putting the lens in the lens frame on which a heat caulking piece-like portion made of a thermoplastic synthetic resin is formed, and pressing a heat caulking tool against the heat caulking piece-like portion to perform heat caulking for allowing the heat caulking piece-like portion to be in close contact with the lens, the lens fixation method comprising:
when the heat caulking tool is to be pressed against the heat caulking piece-like portion,
allowing a first pressing portion of distal end side of the heat caulking tool, to come into contact with a proximal end portion of the heat caulking piece-like portion before the heat caulking tool comes into contact with a distal end portion of the heat caulking piece-like portion;
pressing an outer peripheral portion of the heat caulking piece-like portion by the first pressing portion such that the heat caulking piece-like portion is inclined toward an inner peripheral side after the first pressing portion comes into contact with the heat caulking piece-like portion; and
pressing the distal end portion of the heat caulking piece-like portion toward a caulking region, which is provided on the lens, in an axial direction of the lens frame by a second pressing portion of the heat caulking tool, in a state in which the first pressing portion is in contact with the heat caulking piece-like portion, the second pressing portion being closer to a proximal end of the heat caulking tool than the first pressing portion.

2. A heat caulking tool that is held to be movable along a reference axis and presses a heat caulking piece-like portion, which is formed on a lens frame and made of a thermoplastic synthetic resin, against a lens put in the lens frame to allow the heat caulking piece-like portion to be in close contact with the lens and to fix the heat caulking piece-like portion to the lens, the heat caulking tool comprising:
a first pressing portion that includes a first tapered surface inclined toward the reference axis so as to form a first angle with respect to the reference axis and that is capable of pressing an outer peripheral surface of the heat caulking piece-like portion; and
a second pressing portion that includes a second tapered surface adjacent to an inside from an inner edge of the first tapered surface and inclined toward the reference axis so as to form a second angle which is larger than the first angle with respect to the reference axis, the second pressing portion being capable of pressing a distal end portion of the heat caulking piece-like portion.

3. The heat caulking tool according to claim 2,
wherein an outer edge of the first pressing portion is formed in a range equal to smaller than an outer radius of a proximal end portion of the heat caulking piece-like portion from the reference axis, and
the outer edge of the first pressing portion is provided with a distal end surface that is adjacent to an outside from an outer edge of the first pressing portion and forms a third angle, which is larger than the first angle with respect to the reference axis.

4. The heat caulking tool according to claim 2,
wherein the first angle is larger than 0° and smaller than 45°.

5. The heat caulking tool according to claim 2,
wherein an inner edge portion of the second pressing portion is provided with a third tapered surface that protrudes from the second tapered surface and regulates a position of an inner peripheral side of the heat caulking piece-like portion to be deformed along the second tapered surface.

6. A lens fixation device comprising:
a lens frame holder that holds a lens frame on which a heat caulking piece-like portion made of a thermoplastic synthetic resin is formed such that a central axis of the lens frame is coaxial with a reference axis;
the heat caulking tool according to claim 2; and
a pressing unit that is configured to move the heat caulking tool along the reference axis, press the heat caulking tool against the heat caulking piece-like portion, and allow the heat caulking piece-like portion to be in close contact with a lens.

7. The lens fixation device according to claim 6,
wherein the first pressing portion is configured to come into contact with a proximal end portion of the heat caulking piece-like portion before the heat caulking tool comes into contact with a distal end portion of the heat caulking piece-like portion, and then to press an outer peripheral portion of the heat caulking piece-like portion such that the heat caulking piece-like portion is inclined toward an inner peripheral side, in a case in which the heat caulking tool is to be pressed against the heat caulking piece-like portion, and
the second pressing portion is adapted to press a distal end of the heat caulking piece-like portion toward a caulking region, which is provided on the lens, in an axial direction of the lens frame in a state in which the first pressing portion is in contact with the heat caulking piece-like portion.
